(19) United States
(12) Patent Application Publication
(10) Pub. No.: US 2003/0226343 A1
(43) Pub. Date: Dec. 11, 2003

(54) AN AGRICULTURAL MACHINE FOR PERFORMING CROP PROCESSING

(75) Inventor: Karel van den BERG, Bleskensgraaf (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/250,101

(22) Filed: Jun. 4, 2003

(30) Foreign Application Priority Data
Jun. 6, 2002 (NL) 1020795

(51) Int. Cl. A01D 61/00

(52) U.S. Cl. 56/16.4 R

(57) ABSTRACT

An agricultural machine for performing crop processing. The agricultural machine is provided with a movable agricultural device for performing the agricultural operation. The agricultural machine is an autonomous agricultural machine and is provided with an outlet for discharging processed crop from the agricultural machine, and with a protecting element for protecting the outlet. The protecting element has such a flexibility and such a weight that the processed crop is not harmfully influenced by the protecting element.

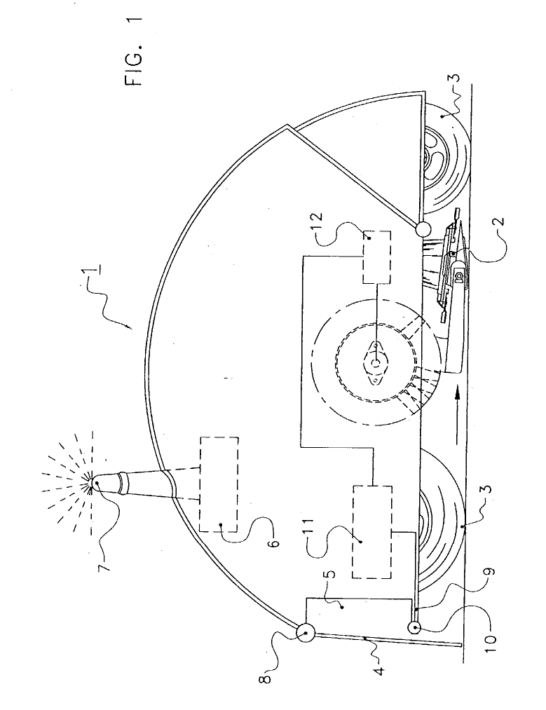

### CROSS REFERENCE TO RELATED APPLICATIONS

This application claims priority from Dutch patent application no. 1020795 filed Jun. 6, 2002, the contents of which are hereby incorporated by reference in their entirety.

### BACKGROUND OF INVENTION

1. Field of the Invention

The invention relates to agricultural machines for performing crop processing, and more particularly to agricultural machines provided with movable agricultural devices for performing an agricultural operation.

2. Description of the Related Art

A drawback of generally known agricultural machines is that the driver of the agricultural machine is principally responsible for the safety of the environment, in particular the safety of human beings and animals. When observing possible danger for the safety of the environment, the driver should activate, on the one hand, an emergency stop that stops the agricultural operation and should operate, on the other hand, the brakes of the tractor, so as to prevent damage or injury. Moreover, each time before putting the agricultural machine into operation, a driver should verify whether somebody or something has crept into or has somehow got into the agricultural machine.

### SUMMARY OF INVENTION

According to the present invention there is provided an agricultural machine for performing crop processing, comprising an improved safety system.

For this purpose, according to the invention an autonomous agricultural machine for performing crop processing comprises a movable agricultural device for performing an agricultural operation, an outlet for discharging processed crop from the agricultural machine and a protecting element for protecting the outlet, the protecting element having such a flexibility and such a weight that the processed crop is not harmfully influenced by the protecting element. On the one hand, by means of such a protecting element penetration into the autonomous agricultural machine is made difficult if not impossible, while, on the other hand, the crop is not harmfully influenced or damaged. The degree of flexibility and the weight of the protecting element can simply be determined per crop by means of experimental tests.

If the protecting element is movably disposed on the agricultural machine, in particular pivotably in a direction away from the outlet, the influence of the protecting element on the crop is reduced further.

In an embodiment of an agricultural machine according to the invention the agricultural machine is provided with a stop for blocking a movement of the protecting element in a direction through the outlet into the agricultural machine, so that penetration into the inner part of the agricultural machine is impeded further, which is beneficial to safety.

A further improvement of safety may be obtained in an embodiment of an agricultural machine according to the invention, in which the agricultural machine is provided with a movement detector for detecting an object that moves through the outlet into the agricultural machine. On the basis of the output of the movement detection, various safety measures can be taken automatically, and the drive of the agricultural machine and/or the drive of the agricultural device can for example be interrupted. The movement detector, more in particular the movement attempt detector with which the agricultural machine is provided, may be constituted by a pressure sensor for detecting a pressure on the protecting element in a direction towards the agricultural machine.

The protecting element is preferably a dragging flap or a dragging plate.

According to a further aspect of the present invention there is also provided a method of safeguarding operation of an autonomous agricultural machine for performing crop processing, the machine having an outlet for discharging processed crop from the agricultural machine, the method comprising providing a protecting element for protecting the outlet, the protecting element having such a flexibility and such a weight that the processed crop is not harmfully influenced by the protecting element; detecting an object that attempts to move through the outlet into the agricultural machine; and automatically interrupting operation of the machine on detection of the object.

### BRIEF DESCRIPTION OF DRAWINGS

An embodiment of the invention will now be explained in further detail by way of example only with reference to the accompanying FIGURE, which shows schematically in side view an autonomous agricultural machine in an embodiment of the invention.

### DETAILED DESCRIPTION

The FIGURE shows schematically in side view an autonomous agricultural machine 1 in an embodiment of the invention. It is pointed out here that an autonomous machine, i.e. a machine that does not require a driver for being moved, but moves with the aid of inter alia a position-determining system, is known per se and will not be set out here in further detail for the sake of simplicity of the description. Such an autonomous machine may for instance be of the type described in U.S. Pat. No. 4,769,700 the contents of which are hereby incorporated by reference in their entirety. Various aspects of an autonomous machine are also disclosed in co-pending U.S. patent applications Ser. No. â [symbol] entitled “An Agricultural Machine for Performing an Agricultural Operation”; Ser. No. â [symbol] entitled “An Agricultural Machine for Performing Crop Processing”; Ser. No. â [symbol] entitled “An Autonomous Agricultural Machine for Performing an Agricultural Operation, in Particular Crop Processing”; Ser. No. â [symbol] entitled “A Device for Crop Processing” Ser. No. â [symbol] entitled “An Assembly for Performing Crop Harvesting” Ser. No. â [symbol] entitled “A System for and a Method of Performing a First and a Second Agricultural Operation on an Agricultural Parcel” Ser. No. â [symbol] entitled “An Assembly for Performing an Agricultural Operation, in Particular Crop Processing” Ser. No. â [symbol] entitled “An Agricultural Machine for Performing an Agricultural Operation, in Particular Crop Processing” and Ser. No. â [symbol] entitled “An Assembly and an Autonomous Agricultural Machine for Performing an Agricultural Operation, in Particular Crop Processing”, all of which claim priority in the Netherlands on Jun. 6, 2002. The contents of all of these applications are hereby incorporated by reference in their entirety.

The autonomous agricultural machine 1 is suitable for performing an agricultural operation, in particular a crop processing operation, on a crop that is present on an agricultural parcel. In the embodiment shown the autonomous agricultural machine 1 is an autonomous mowing machine that mows crop that is present on the agricultural parcel by means of a mowing unit 2. Although several sorts of mowing units known per se may be used, in the embodiment shown the mowing unit 2 is constituted by mowing discs that are present on a cutter bar and are rotatable about an axis, which mowing discs are provided with mowing knives. It will be obvious that the agricultural machine may also be an agricultural machine for performing other crop processing operations.

The agricultural machine 1 is supported and moved over the agricultural parcel by means of wheels 3. The autonomous agricultural machine 1 further comprises a protecting element 4, in the embodiment shown constituted by a dragging plate (although other protecting means, such as a dragging flap, downwardly hanging arms, etc.) may be applied as well for protecting an outlet 5 for discharging processed crop from the agricultural machine 1. The protecting element 4 has such a flexibility and such a weight that the processed crop is not harmfully influenced by the protecting element 4.

The agricultural machine 1 further comprises a position determining element 6 known per se, in the embodiment shown provided with an aerial 7, for determining the position of the autonomous agricultural machine 1 in the agricultural parcel by means of for example a GPS system.

The dragging plate 4 is disposed on the agricultural machine 1 so as to be pivotable about a pivot axis 8. It is pointed out here that other ways of being movably disposed, for example by means of a parallelogram suspension, by means of telescopic pistons or the like, may also be applied within the scope of the invention. In the embodiment shown, a pivotal movement in the direction of the outlet 5 is possible, while by means of a stop 9 the movement of the dragging plate 4 in a direction through the outlet into the agricultural machine 1 is blocked.

A pressure sensor 10 for detecting a pressure on the dragging plate 4 is disposed on the stop 9 and detects pressure on the dragging plate 4 in a direction towards, the agricultural machine 1. It is pointed out here that other movement detectors, such as for example a camera with picture recognition, for detecting a movement of an object through the outlet 5 into the agricultural machine 1 may also be applied within the scope of the invention.

In dependence on the measurement result of the pressure sensor 10, various safety measures can be taken automatically; for example the drive 11 of the wheels 3 of the agricultural machine 1 and/or the drive 12 of the mowing unit 2 can be interrupted.

Many modifications in addition to those described above may be made to the structures and techniques described herein without departing from the spirit and scope of the invention. In particular, the devices and methods disclosed herein may also be used in conjunction with further features of the above-referenced co-pending applications. Accordingly, although specific embodiments have been described, these are examples only and are not limiting upon the scope of the invention.

1. An autonomous agricultural machine for performing processing of a crop, the agricultural machine comprising:
a movable agricultural device for performing an agricultural operation;
an outlet for discharging the processed crop from the agricultural machine; and
a protecting element for protecting the outlet, the protecting element having such a flexibility and such a weight that the processed crop is not harmfully influenced by the protecting element.

2. The agricultural machine as claimed in claim 1, wherein the protecting element is movably disposed on the agricultural machine.

3. The agricultural machine as claimed in claim 2, wherein the agricultural machine further comprises a stop for blocking a movement of the protecting element through the outlet into the agricultural machine.

4. The agricultural machine as claimed in claim 1, wherein the agricultural machine further comprises a movement detector for detecting an object that moves through the outlet into the agricultural machine.

5. The agricultural machine as claimed in claim 3, wherein the agricultural machine further comprises a movement detector for detecting an object that moves through the outlet into the agricultural machine.

6. The agricultural machine as claimed in claim 1, wherein the agricultural machine further comprises a pressure sensor for detecting a pressure on the protecting element in a direction towards the agricultural machine.

7. The agricultural machine as claimed in claim 4, wherein the agricultural machine further comprises a pressure sensor for detecting a pressure on the protecting element in a direction towards the agricultural machine.

8. The agricultural machine as claimed in claim 5, wherein the movement detector comprises a pressure sensor for detecting a pressure exerted by the protecting element against the stop.

9. The agricultural machine as claimed in claim 2, wherein the protecting element is a dragging flap or a dragging plate.

10. The agricultural machine as claimed in claim 5, wherein the protecting element is a dragging flap or a dragging plate.

11. The agricultural machine as claimed in claim 8, wherein the protecting element is a dragging flap or a dragging plate.

12. A method of safeguarding operation of an autonomous agricultural machine for performing processing of a crop, the machine having an outlet for discharging the processed crop from the agricultural machine, the method comprising:
providing a protecting element for protecting the outlet, the protecting element having such a flexibility and such a weight that the processed crop is not harmfully influenced by the protecting element;
detecting an object that attempts to move through the outlet into the agricultural machine; and
automatically interrupting operation of the machine on detection of the object.

13. The method as claimed in claim 12, wherein the autonomous agricultural machine further comprises a pressure sensor and the detection of the object is by detecting pressure on the protecting element in a direction towards the agricultural machine.
